(19) United States
(12) Patent Application Publication
(10) Pub. No.: US 2013/0228135 A1
(43) Pub. Date: Sep. 5, 2013

(54) PET HABITAT SYSTEM

(71) Applicant: MICHAEL DAVID PRESCOTT, Las Vegas, NV (US)

(72) Inventor: MICHAEL DAVID PRESCOTT, Las Vegas, NV (US)

(21) Appl. No.: 13/410,284

(22) Filed: Mar. 1, 2012

(51) Int. Cl. A01K 1/02; A01K 1/03; A01K 1/00

(52) U.S. Cl. 119/455; 119/498; 119/501

(57) ABSTRACT

The present invention is a pet habitat system that includes a base kennel body that extends upwards at a bottom portion and a top portion that extends downward at the top portion forming the base kennel body, a latched kennel gate that is positioned on the system between the bottom portion and the top portion and fixed kennel gates that are positioned on the remaining 3 sides of the system between the bottom portion and the top portion of the base kennel body. The system also includes a wall bracket that is fittingly disposed around a doggie door to removably attach the system to the doggie door, a plurality of locking pins to secure the bottom portion and the top portion of the base kennel body and locking sleeves that assist to removably secure or lock the system to the wall bracket.

### TECHNICAL FIELD & BACKGROUND

Leaving a pet such as a dog or cat alone unattended in a home or residence can often lead to the pet damaging furniture, carpeting, furnishings or other items in the home or residence.

It is an object of the present invention to provide a pet habitat system that can safely and comfortably confine a pet to prevent the pet from damaging furniture, carpeting, furnishings or other items in a home or a residence.

It is an object of the present invention to provide a pet habitat system that is versatile and relatively easy to assemble.

It is an object of the present invention to provide a pet habitat system that can be utilized in a plurality of orientations with a doggie door or another pet habitat system. What is really needed is a pet habitat system that can safely and comfortably confine a pet to prevent the pet from damaging furniture, carpeting, furnishings or other items in a home or a residence that is versatile and relatively easy to assemble that can be utilized in a plurality of orientations with a doggie door or another pet habitat system.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a front exploded perspective view of a pet habitat system, in accordance with one embodiment of the present invention.

FIG. 2 illustrates a front perspective view of a pet habitat system, in accordance with one embodiment of the present invention.

FIG. 3 illustrates a front perspective view of a pet habitat system, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase in one embodiment is utilized repeatedly. The phrase generally does not refer to the same embodiment, however, it may. The terms comprising, having and including are synonymous, unless the context dictates otherwise.

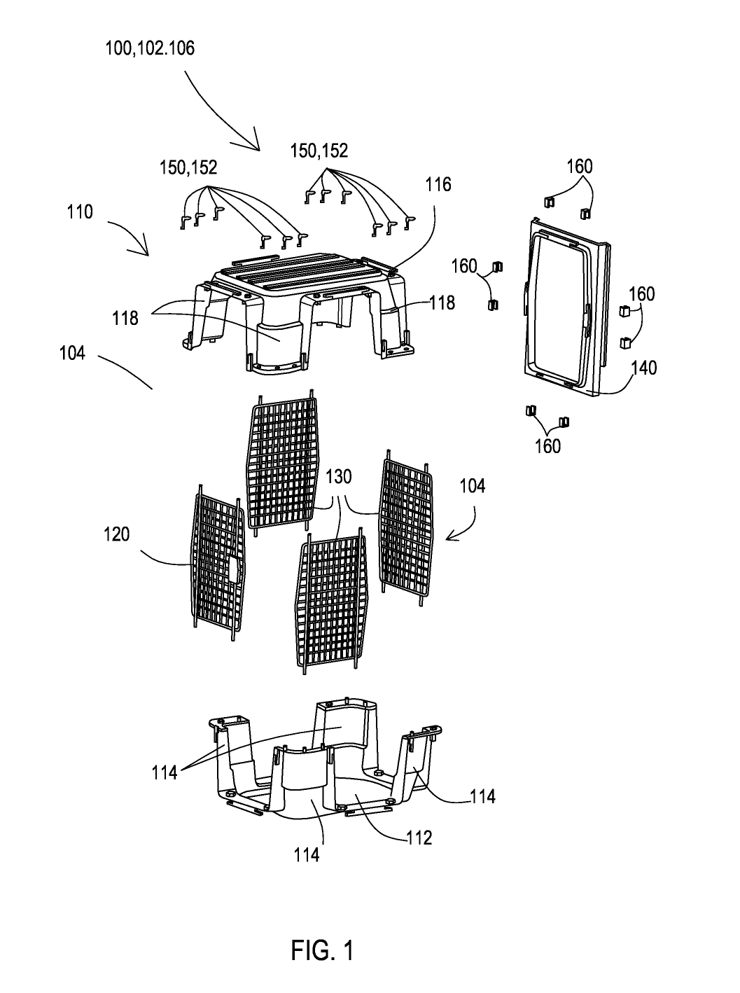

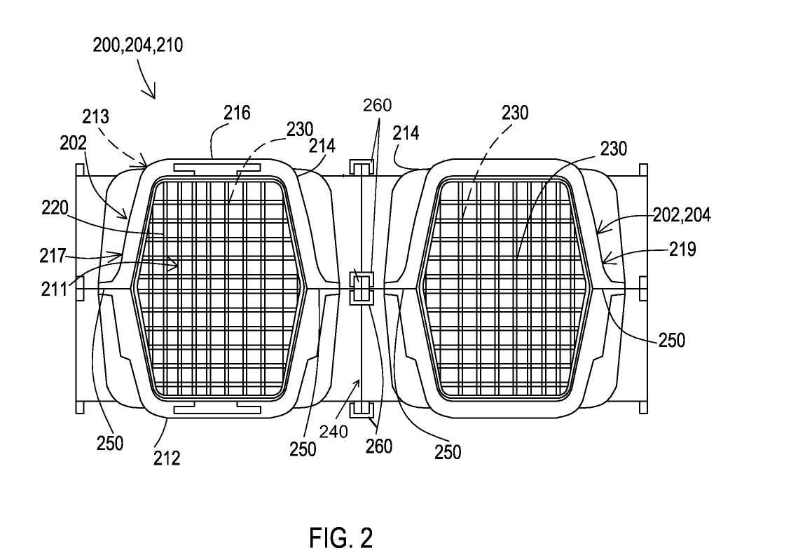

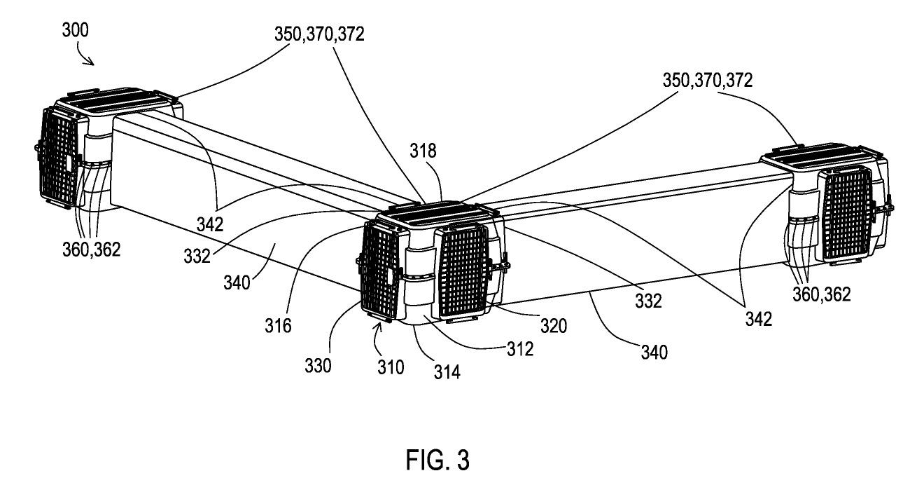

FIG. 1 illustrates a front exploded perspective view of a pet habitat system 100, in accordance with one embodiment of the present invention. The pet habitat system 100 is a single kennel module 102 that can be removably attached to a doggie door (not shown) or an additional single kennel module 102 as further illustrated and described in FIGS. 2 and 3 and their descriptions.

The pet habitat system 100 has 4 sides 104 and a generally rectangular shape 106 that includes a base kennel body 110, a latched kennel gate 120, a plurality of fixed kennel gates 130, a wall bracket 140, a plurality of locking pins 150 and a plurality of locking sleeves 160. The base kennel body 110 has a bottom portion 112 that extends upwards at each corner 114 of the bottom portion 112 and a top portion 116 that extends downward at each corner 118 of the top portion 116 forming the base kennel body 110. The latched kennel gate 120 is positioned on one side 104 of the pet habitat system 100 between the bottom portion 112 and the top portion 116 and is where a contained pet will enter and exit the pet habitat system 100. The fixed kennel gates 130 are positioned on the remaining 3 sides 104 of the pet habitat system 100 between the bottom portion 112 and the top portion 116 of the base kennel body 110. The wall bracket 140 is fittingly disposed around the doggie door to removably attach any side 104 of the pet habitat system 100 to the doggie door. The wall bracket 140 has suitable dimensions to accommodate a plurality of typical doggie door dimensions and sizes. The locking pins 150 secure the bottom portion 112 and the top portion 116 of the base kennel body 110 in addition to the latched kennel gate 120 and fixed kennel gates 130 within the sides 104 of pet habitat system 100. The locking pins 150 have a general t-shape 152 to facilitate relatively easy grasping but can be any suitable shape. The locking sleeves 160 assist to removably secure or lock one of the sides 104 of pet habitat system 100 to the wall bracket 140. The locking sleeves 160 have a rectangular hollow shape 162 but can have any suitable shape.

FIG. 2 illustrates a front perspective view of a pet habitat system 200, in accordance with one embodiment of the present invention. The pet habitat system 200 is designed to safely and comfortably confine a pet without utilizing a doggie door. The pet habitat system 200 is a pair of single kennel modules 202 similar to the single kennel module 102 illustrated and described in FIG. 1 and its description that can be removably attached to an additional single kennel module 102 forming the pet habitat system 200. The pet habitat system 200 is a double kennel module 204 where a pet can move between the pair of single kennel modules 202 or can accommodate more than one pet.

The pet habitat system 200 utilizes similar components to the single kennel module 102 illustrated and described in FIG. 1 and its description and includes a pair of base kennel bodies 210, a latched kennel gate 220, a plurality of fixed kennel gates 230, a wall bracket 240, a plurality of locking pins 250 and a plurality of locking sleeves 260. The base kennel bodies 210 each have a bottom portion 212 that extends upwards at each corner 214 of the bottom portion 212 and a top portion 216 that extends downward at each corner 218 of the top portion 216 forming the base kennel body 210. Each of the base kennel bodies 210 has a front 211, a back 213 and two sides 215. The latched kennel gate 220 is secured between the bottom portion 212 and the top portion 216 at the front 211 of a first base kennel body 217. The fixed kennel gates 230 are secured between the bottom portion 212 and the top portion 216 at the back 213 of the first base kennel body 217 and at the front 211 and the back 213 of a second base kennel body 219. The wall bracket 240 removably attaches the first base kennel body 217 to the second base kennel body 219 where a pet can move between the first base kennel body 217 and the second base kennel body 219 as desired. The locking pins 250 secure the bottom portion 212 and the top portion 216 of the first base kennel body 217 and the second base kennel body 219. The locking sleeves 260 fasten the wall bracket 240 that removably attaches the first base kennel body 217 to the second base kennel body 219.

FIG. 3 illustrates a front perspective view of a pet habitat system 300, in accordance with one embodiment of the present invention. The pet habitat system 300 can be configured in a plurality of ways or orientations and is well suited for 1 or more pets that like to play together.

The pet habitat system 300 includes a base kennel body 310, a latched kennel gate 320, a fixed kennel gate 330, a pair of Nylon Water proof tunnels 340, a plurality of wall brackets 350, a plurality of locking pins 360 and a plurality of locking sleeves 370.

The base kennel body 310 has a bottom portion 312 that extends upwards at each corner 314 of the bottom portion 312 and a top portion 316 that extends downward at each corner 318 of the top portion 316 forming the base kennel body 310. The latched kennel gate 320 is positioned on one side 302 of the pet habitat system 300 between the bottom portion 312 and the top portion 316 and is where a contained pet will enter and exit the pet habitat system 100. The fixed kennel gate 330 is provided on the base kennel body 310 and a pair of open sides 332 is provided across from the fixed kennel gate 330 and the latched kennel gate 320. The pair of Nylon waterproof tunnels 340 is attached and extends from the pair of open sides 332 and can be made of any other suitable material and is approximately 6 inches in diameter or can be any other suitable diameter. The pair of Nylon waterproof tunnels 340 also include a steel spring (not shown) and is attached to the pair of open sides 332 at the top portion 316 of the base kennel body 310. The wall brackets 350 secure both ends 342 of the pair of Nylon waterproof tunnels 340 to another base kennel body 310 or a doggie door and the pair of open sides 332. The locking pins 360 secure the bottom portion 312 and the top portion 316 of the base kennel body 310 in addition to the latched kennel gate 320 and fixed kennel gate 330 within the pair of sides 332 of pet habitat system 300. The locking pins 360 have a general t-shape 362 to facilitate relatively easy grasping but can be any suitable shape. The locking sleeves 370 assist to removably secure or lock the wall brackets 350 and secure both ends 342 of the pair of Nylon waterproof tunnels 340 to another base kennel body 310 or a doggie door and the pair of open sides 332. The locking sleeves 370 have a rectangular hollow shape 372 but can have any suitable shape.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A pet habitat system that has 4 sides, comprising:
a base kennel body with a bottom portion and 4 corners that extends upwards at said corners of said bottom portion and a top portion and 4 corners that extends downward at said corners of the top portion forming said base kennel body;
a latched kennel gate that is positioned on one said side of said pet habitat system between said bottom portion and said top portion;
a plurality of fixed kennel gates that are positioned on 3 remaining said sides of said pet habitat system between said bottom portion and said top portion of said base kennel body;
a wall bracket that is fittingly disposed around a doggie door to removably attach any said side of said pet habitat system to said doggie door;
a plurality of locking pins to secure said bottom portion and said top portion of said base kennel body; and
a plurality of locking sleeves that assist to removably secure or lock one of said sides of said pet habitat system to said wall bracket.

2. The system according to claim 1, wherein said latched kennel gate is where a pet will enter and exit said pet habitat system.

3. The system according to claim 1, wherein said locking pins secure said latched kennel gate and said fixed kennel gates within said sides of said pet habitat system.

4. The system according to claim 1, wherein said locking pins have a general t-shape to facilitate easy grasping.

5. The system according to claim 1, wherein said locking sleeves have a rectangular hollow shape.

6. The system according to claim 1, wherein said pet habitat system has a generally rectangular shape.

7. The system according to claim 1, wherein said pet habitat system is a single kennel module that can be removably attached to said doggie door or said additional single kennel module.

8. A pet habitat system, comprising:
a pair of base kennel bodies each with a front, a back, two sides, a top portion and a bottom portion;
a latched kennel gate that is secured between said bottom portion and said top portion at said front of a first base kennel body;
a plurality of fixed kennel gates that are secured between the bottom portion and the top portion at the back of said first base kennel body and at said front and said back of a second base kennel body;
a wall bracket that removably attaches said first base kennel body to said second base kennel body that allows a pet to move between said first base kennel body and said second base kennel body as desired;
a plurality of locking pins that secure said bottom portion and said top portion of said first base kennel body and said second base kennel body; and
a plurality of locking sleeves that fasten said wall bracket that removably attaches said first base kennel body to said second base kennel body.

9. The pet habitat system according to claim 8, wherein said pet habitat system is designed to safely and comfortably confine said pet without utilizing a doggie door.

10. The pet habitat system according to claim 8, wherein said pet habitat system is a single kennel module that can be removably attached to an additional said single kennel module forming said pet habitat system.

11. The pet habitat system according to claim 8, wherein said pet habitat system is a double kennel module where said pet can move between said pair of single kennel modules.

12. The pet habitat system according to claim 8, wherein said pet habitat system can accommodate more than one said pet.

13. A pet habitat system, comprising:
a base kennel body that has a bottom portion that extends upwards at 4 corners of said bottom portion and a top portion that extends downward at each corner of said top portion forming said base kennel body;
a latched kennel gate that is positioned on one side of a pet habitat system between said bottom portion and said top portion;
a fixed kennel gate that is provided on said base kennel body and a pair of open sides is provided across from said fixed kennel gate and said latched kennel gate;
a pair of waterproof tunnels with two ends that is attached and extends from said pair of open sides;
a plurality of wall brackets that secure both ends of said pair of waterproof tunnels to another said base kennel body or a doggie door and said pair of open sides;
a plurality of locking pins that secure the bottom portion and said top portion of said base kennel body; and
a plurality of locking sleeves that assist to removably secure or lock said wall brackets and secure said both ends of said pair of waterproof tunnels to another base kennel body or a doggie door and said pair of open sides.

14. The pet habitat system according to claim 13, wherein said latched kennel gate is where said pet will enter and exit said pet habitat system.

15. The pet habitat system according to claim 13, wherein said pair of waterproof tunnels are made of Nylon.

16. The pet habitat system according to claim 13, wherein said pair of waterproof tunnels are approximately 6 inches in diameter.

17. The pet habitat system according to claim 13, wherein said locking pins secure said bottom portion and said top portion of said base kennel body.

18. The pet habitat system according to claim 13, wherein said locking pins secure said latched kennel gate and said fixed kennel gate to said pair of sides of said pet habitat system.

19. The pet habitat system according to claim 13, wherein said locking pins have a general t-shape to facilitate easy grasping.

20. The pet habitat system according to claim 13, wherein said locking sleeves have a rectangular hollow shape.
